(19) United States
(12) Patent Application Publication
(10) Pub. No.: US 2025/0131519 A1
(43) Pub. Date: Apr. 24, 2025

(54) SYSTEMS AND METHODS FOR ASSET COMBINATION DISPLAY AND EXECUTION

(71) Applicant: Wells Fargo Bank, N.A., San Francisco, CA (US)

(72) Inventors: Mathew Degenhardt, San Francisco, CA (US); Jaclyn Olmos-Lym, San Francisco, CA (US)

(73) Assignee: Wells Fargo Bank, N.A., San Francisco, CA (US)

(21) Appl. No.: 18/381,548

(22) Filed: Oct. 18, 2023

(51) Int. Cl. G06Q 50/18

(52) U.S. Cl. CPC G06Q 50/186

(57) ABSTRACT

A system includes a processing circuit configured to receive asset data relating to assets of an entity and asset integration parameters. The processing circuit is further configured to model the asset data with the asset integration parameters to generate asset integration data for the assets. The asset integration data corresponds to two or more of the assets that may be combined based on the asset integration parameters. The processing circuit is further configured to generate and provide, to a graphical user interface (GUI) of a user device, an interface corresponding to the asset integration data. The interface includes a plurality of elements illustrating the two or more of the assets that may be combined.

### TECHNICAL FIELD

The present disclosure relates generally to the field of estate planning, including displaying and executing asset combinations and other transactions.

### BACKGROUND

People typically have difficulty determining how their assets may be simplified before they pass away. For example, in some instances, a person may not be able to determine that a first asset may be combined with a second asset to simplify their estate for an executor after the person has passed away. Because managing an estate of a person after the person has passed away may be difficult for an executor of the estate, people strive to understand how their assets may be combined or changed, and to execute those transactions to simplify their estate.

### SUMMARY

Some arrangements relate to a system. In some arrangements, the system includes a processing circuit. In some arrangements, the processing circuit includes memory and one or more processors. In some arrangements, the processing circuit is configured to receive asset data relating to assets of an entity and asset integration parameters. In some arrangements, the processing circuit is also configured to model the asset data with the asset integration parameters to generate asset integration data for the assets. In some arrangements, the asset integration data corresponds to two or more of the assets that may be combined based on the asset integration parameters. In some arrangements, the processing circuit is also configured to generate and provide, to a graphical user interface (GUI) of a user device, an interface corresponding to the asset integration data. In some arrangements, the interface includes a plurality of elements illustrating the two or more of the assets that may be combined.

Some arrangements relate to a method. In some arrangements, the method includes receiving, by a processing circuit, asset data relating to assets of an entity and asset integration parameters. In some arrangements, the method also includes modeling the asset data with the asset integration parameters to generate asset integration data for the two or more of the assets. In some arrangements, the asset integration data corresponds to two or more of the assets that may be combined based on the asset integration parameters. In some arrangements, the method also includes generating and providing, to a graphical user interface (GUI) of a user device, an interface corresponding to the asset integration data. In some arrangements, the interface comprises a plurality of elements illustrating the two or more of the assets that may be combined.

Some arrangements relate to a computer-readable storage medium (CRM) having instructions stored thereon that, when executed by a processing circuit, cause the processing circuit to perform operations. The operations include receiving, by the processing circuit, asset data relating to assets of an entity and asset integration parameters. In some arrangements, the operations also include modeling the asset data with the asset integration parameters to generate asset integration data for the two or more of the assets. In some arrangements, the asset integration data corresponds to two or more of the assets that may be combined based on the asset integration parameters. In some arrangements, the operations also include generating and providing, to a graphical user interface (GUI) of a user device, an interface corresponding to the asset integration data. In some arrangements, the interface comprises a plurality of elements illustrating the two or more of the assets that may be combined. In some arrangements, the plurality of elements comprise a recommendation to integrate the two or more of the assets that may be combined.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a block diagram of a computing environment including an asset combination system, according to example embodiments.

FIG. 2 is a block diagram illustrating an example computing system suitable for use in the example embodiments described herein.

FIG. 3 is a flow diagram of a method for displaying and executing asset combinations, according to example embodiments.

FIG. 4A is an illustration of a configuration of a user interface generated by the asset combination system of FIG. 1, according to example embodiments.

FIG. 4B is an illustration of an additional configuration of a user interface generated by the asset combination system of FIG. 1, according to example embodiments.

FIG. 4C is an illustration of an additional configuration of a user interface generated by the asset combination system of FIG. 1, according to example embodiments.

FIG. 4D is an illustration of an additional configuration of a user interface generated by the asset combination system of FIG. 1, according to example embodiments.

FIG. 4E is an illustration of an additional configuration of a user interface generated by the asset combination system of FIG. 1, according to example embodiments.

### DETAILED DESCRIPTION

Referring generally to the figures, systems, and methods for displaying and executing asset combinations are disclosed according to various embodiments herein. In some instances, the systems and methods provide combination indicators indicative that liabilities held by an entity (e.g., an estate, a person, an organization, a corporation, etc.) may be combined, such that a user is made aware of how to reduce the total number of assets and liabilities held by the entity. Additionally, in some instances, the systems and methods described herein include combining the assets of the entity that are combinable, providing instructions to the user on how to combine the assets that are combinable, or execute actions to combine the assets.

In some instances, the systems and methods determine a projected passing date that corresponds to a predicted date that a person associated with the entity will pass away. For example, in some instances, the systems and methods described herein use one or more trained machine learning models to estimate a date that the person will pass away based on population data and individual data related to the person. The systems and methods described herein then provide the projected passing date to the user, such that the user may take actions to reduce the total number of assets owned by the entity and liabilities held by the entity before the death of the person.

Accordingly, the systems and methods described herein provide a variety of improvements to estate planning systems. For example, traditional estate planning systems have not been configured to provide a user with assets owned by an entity and/or liabilities held by the entity that may be combined. As such, after the entity ceases to exist, a representative (e.g., an executor, a trustee, an attorney, a next of kin, a beneficiary, an administrator, etc.) responsible for managing the assets and/or liabilities held by the entity may be overwhelmed with a quantity of the assets and/or the liabilities held by the entity, and at which point the person associated with the entity may no longer be available to assist with organizing the assets and/or the liabilities. Additionally, the representative being overwhelmed with the quantity of the assets and/or liabilities may result in the representative making mistakes and/or managing the assets and/or liabilities in a way that was not desired by the entity. Further, even if the person associated with the entity was aware of how the assets owned by the entity and/or liabilities held by the entity could be combined, traditional estate planning systems have not provided projected passing dates so that the person may take actions to combine the assets and/or liabilities before the date that the person is likely to die.

The systems and methods described herein solve these issues by providing users with combination indicators indicative of assets owned by an entity and/or liabilities held by the entity that may be combined, such that the user may combine the assets owned by the entity and/or the liabilities held by the entity that are combinable and reduce the total number of the assets and/or the liabilities associated with the entity. In some arrangements, the assets held by the entity or the liabilities held by the entity may be combined if the assets or the liabilities belong to a same category of asset or liability (e.g., a savings account, an investment fund, a post-tax retirement account, a pre-tax retirement account, a loan, credit card debt, etc.). Reducing the total number of the assets and/or the liabilities associated with the entity may ease the process of a representative responsible for managing the assets and/or liabilities held by the entity after the entity has ceased to exist. In some arrangements, combining the assets owned by the entity may result in a reduction to an amount of fees and/or taxes associated with the assets. In some arrangements, combining the liabilities owed by the entity may result in a reduction to an amount of interest accrued over a period of time associated with the liabilities. In some embodiments, other transactions than combining assets may be desired, such as account closures, cashing out of accounts, opening a new account and transferring assets from two or more other accounts into the new account, and so on. As such, a person associated with the entity may make decisions to combine the assets and/or the liabilities which may simplify the assets and/or liabilities held by the entity. The person associated with the entity may also be provided with a projected passing date so the person may make decisions to combine the assets and/or liabilities before the date that the person is likely to pass away and pass a responsibility to manage the assets and/or liabilities to a representative.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

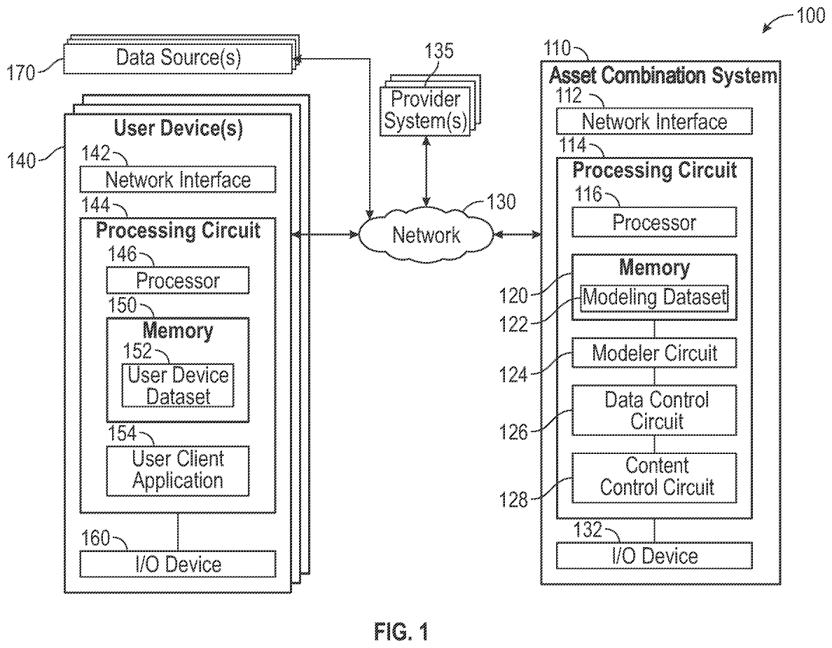

Referring to FIG. 1, a block diagram of a computing environment 100 including an asset combination system 110 is shown, according to potential embodiments. The asset combination system 110 can be associated with a provider, such as a service provider, bank, or financial institution (FI). The computing environment 100 further includes one or more user devices (e.g., user device 140), one or more data sources (e.g., data source 170), and one or more provider systems (e.g., the provider system 135). In some embodiments, the asset combination system 110, user device 140, and data source 170 are communicatively coupled. The various components of the computing environment are in communication with each other and are connected by a network 130.

Although the various systems and devices are shown in FIG. 1 as being singular, it will be understood that, in some instances, the computing environment 100 includes one or multiple of any of the various illustrated systems and/or devices, as desired for a given application. Similarly, while the following descriptions of the various systems and devices are largely provided in terms of single systems or devices, it will be appreciated that these descriptions are similarly applicable to any additional corresponding systems and/or devices (e.g., additional of the provider systems 135, additional of the user devices 140, and so on).

The asset combination system 110 may be operated by a provider, such as an entity, a consultant, a retailer, a service provider, and so on. The asset combination system 110 includes a network interface 112 that connect the asset combination system 110 to the network 130. The network interface 112 facilitates secure communications between the asset combination system 110 and various other components of the computing environment 100. The network interface 112 also facilitates communication with other entities (e.g., provider systems 135, etc.), such as other banks, healthcare systems, and so on. Further, in some arrangements, the network interface 112 includes cryptography capabilities to establish a secure or relatively secure communication session in which data communicated over the session is encrypted.

The processing circuit 114 includes a processor 116, a memory 120, a modeler circuit 124, a data control circuit 126, and a content control circuit 128. In other embodiments, the processing circuit 114 may contain more or less components than are shown in FIG. 1. The processor 116 may be implemented as one or more application specific integrated circuits (ASICs), field programmable gate arrays (FPGAs), a group of processing components, or other suitable electronic processing components. The memory 120 may be a device for storing data and/or computer code. The memory 120 may store data associated with a variety of application programs ran by the asset combination system 110. One such application may be to provide data to the modeler circuit 124, data control circuit 126, and content control circuit 128. The memory 120 can store a variety of data related to the modeler circuit 124 in a modeling dataset 122, which may be used by the modeler circuit 124 as discussed herein.

The modeler circuit 124 is structured or configured to perform a variety of the functionalities described herein. As will be described in detail below, with regard to FIG. 3, the modeler circuit 124 is configured to provide asset integration data to a user that is indicative of how assets owned by an entity (e.g., a holding, assets owned by a person, etc.) may be combined to simplify an asset portfolio of the entity based on asset integration parameters. As used herein, “asset integration parameters” is used to refer to data, rules, and/or guidelines that may be used to determine the feasibility and/or favorability of combining assets of an entity. As will similarly be described below, in some instances, the modeler circuit 124 is further configured to provide instructions to the user which include steps that the user can take to combine the assets that may be combined from the asset integration data. In some instances, the modeler circuit 124 is additionally configured to provide liability integration data to the user that is indicative of how liabilities held by the entity may be combined to simplify a liability portfolio of the entity. In some instances, the modeler circuit 124 is further configured to provide a distribution discrepancy to the user that is indicative of a variation between two or more documents associated with the entity that detail how the assets of the entity should be distributed after the entity ceases to exist (e.g., a person passes away, an organization dissolves, etc.). In some instances, the modeler circuit 124 is further configured to provide a projected passing date for a person associated with the entity that is indicative of a projection of a date that the person will pass away based on information associated with the person and lifespan projection parameters. As used herein, “lifespan projection parameters” is used to refer to data and data trends that may be compared with information related to an individual to project how much longer the individual will live.

The data control circuit 126 is configured to fuse data, including operations to generate various data structures stored in the memory 120 and used by the various circuits described herein. The data control circuit 126 can also be configured to receive data from multiple sources (e.g., the data sources 170, the provider systems 135, the user devices 140, etc.) and aggregate the data into various data structures stored in the memory 120.

The content control circuit 128 is configured to generate content for displaying to users. The content can be selected from various resources (e.g., a request for a photograph of an asset from the data control circuit 126). The content control circuit 128 can also be structured to provide content (e.g., via a graphical user interface (GUI)) to the user device 140 over the network 130, for display. The content can also include actionable items that the user may select or otherwise manipulate. The content can be selected from various resources (e.g., from the data control circuit 126, from the memory 120, etc.).

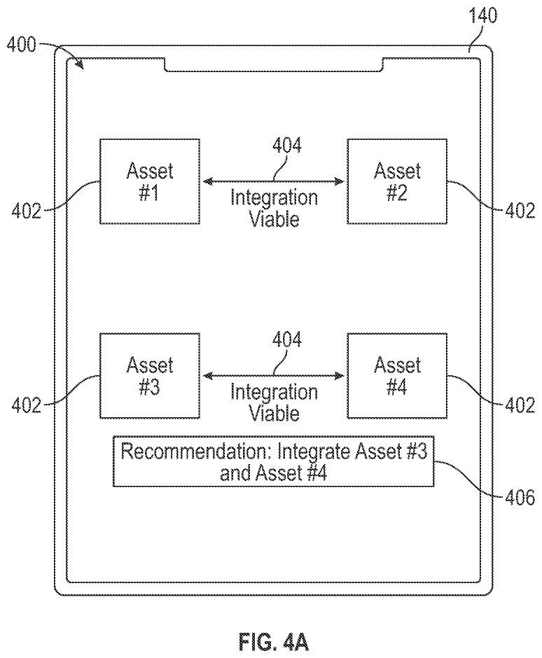

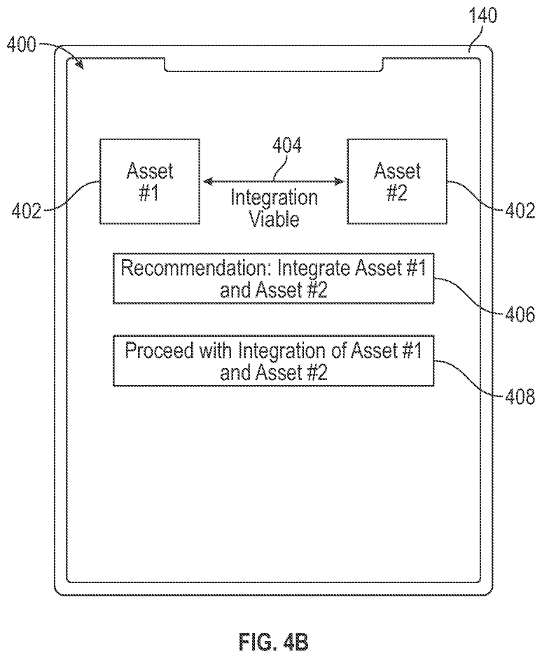

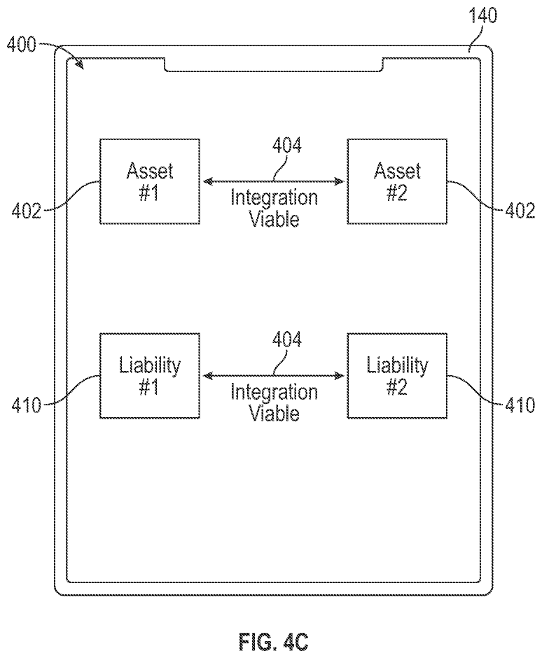

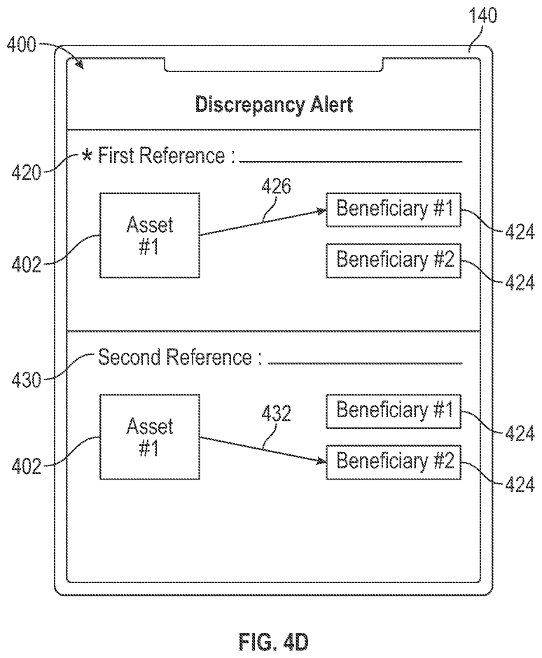

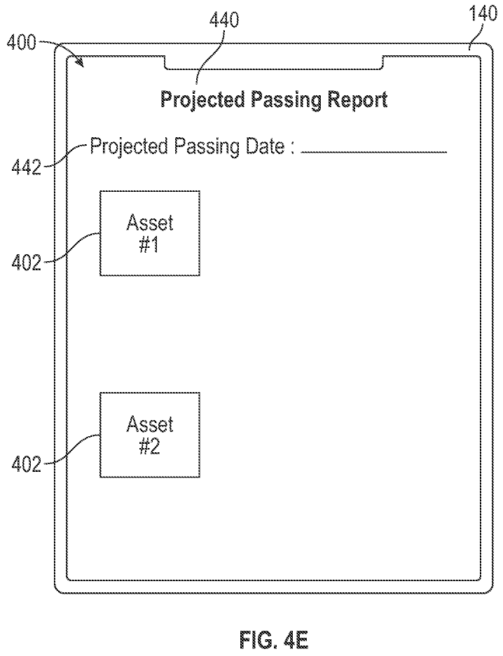

The content generated by the content control circuit 128 can include customized dashboards, such as those described in detail below, with reference to FIGS. 4A-4E. The content control circuit 128 can generate customized user-interactive dashboards for one or more entities, such as the user device 140, based on data received from the user device 140, data source 170, and/or any other computing device described therein. The generated dashboards can include various data (e.g., data stored in the content control circuit 128 and/or modeling dataset 122) associated with one or more assets such as valuations, photographs or videos, descriptions, and/or others. In certain embodiments, the asset combination system 110 includes an application programming interface (API) and/or a software development kit (SDK) that facilitate the integration of other applications with the asset combination system 110. For example, the asset combination system 110 is configured to utilize the functionality of the user device 140 interacting through an API.

The content control circuit 128 can generate an interface corresponding to the asset integration data (e.g., generated by the modeler circuit 124). In some embodiments, the interface may include elements (e.g., text, images, buttons, videos, etc.) illustrating the assets that may be combined based on the asset integration data. The elements may include a recommendation for the user to integrate the assets that may be combined. For example, the interface may include a first asset and a second asset that are associated with an element indicating that there is a viable integration between the first asset and the second asset. In some embodiments, the interface may also correspond to the liability integration data (e.g., generated by the modeler circuit 124) and the elements may also illustrate the liabilities that may be combined based on the liability integration data.

The input/output device 132 is structured to receive communications from and provide communications to users associated with the asset combination system 110. The input/output device 132 can be structured to exchange data, communications, instructions, etc. with an input/output component of the asset combination system 110 (e.g., a mouse, a monitor, a keyboard, etc.). As such, the input/output device 132 may provide an interface for the user to interact with various applications stored on the asset combination system 110.

The user device 140 is owned, operated, controlled, and/or otherwise associated with a person (e.g., a person looking to simplify their asset portfolio, a financial advisor, a lawyer, a banker, etc.). In some embodiments, the user device 140 may be or may include, for example, a desktop or laptop computer (e.g., a tablet computer), a smartphone, a wearable device (e.g., a smartwatch), a personal digital assistant, and/or any other suitable computing device. The user devices 140 may each include a network interface 142, a processing circuit 144, and an input/output device 160. The network interface 142, the processing circuit 144, and the input/output device 160 may be structured and function substantially similar to and include the same or similar components as the network interface 112, the processing circuit 114, and the input/output device 132 described above, with reference to the asset combination system 110. Therefore, it should be understood that the description of the network interface 112, the processing circuit 114, and the input/output device 132 of the asset combination system 110 provided above may be similarly applied to the network interface 142, the processing circuit 144, and the input/output device 160 of each of the user devices 140. The network interface 142 may similarly facilitate secure communications between the user device 140 and various other components of the computing environment 100. The processing circuit 144 similarly includes a memory 150 and a processor 146. The memory 150 and the processor 146 are substantially similar to the memory 120 and the processor 116 described above. Accordingly, the user devices 140 are similarly configured to run a variety of application programs and store associated data in a database of the memory 150. The variety of application programs and associated data may be stored as user device dataset 152.

Additionally, processing circuit 144 of each of the user devices 140 may each store, in the memory 150, and execute (“run”) user client applications 154, such as an Internet browser presenting websites and/or applications provided or authorized by entities implementing or administering any of the computing systems in computing environment 100 to enable the customer to perform or otherwise interact with various methods and operations described herein. For example, in some instances, the user client applications 154 comprise a provider client application (e.g., a financial institution banking application) provided by and at least partly supported by the asset combination system 110 and configured to enable various functionality described herein. In some instances, the user client applications 154 comprise a provider client application provided by and at least partly supported by the provider system 135 and configured to enable various functionality described herein.

In some instances, the user client application 154 is additionally coupled to various components within the computing environment 100 (e.g., the asset combination system 110, the provider system 135) via one or more application programming interfaces (APIs) and/or software development kits (SDKs) to integrate one or more features or services provided by the various components to enable the various methods and operations described herein. For example, in some instances, a provider client application provided to the user device 140 by the asset combination system 110 implements various functionality of the provider system 135 via one or more APIs and/or SDKs to allow for various functionality and/or information provided and/or stored by the provider system 135 to be utilized or otherwise implemented within the context of the provider client application.

Additionally, the user client application 154 is configured to output information to a display of user device 140 regarding information received from the asset combination system 110. For example, the user client application 154 is configured to communicate with a user interface to show graphics regarding content associated with an asset, such as a photograph or video, a valuation, or a description. Further, a user response to a display of user device 140 regarding information from the asset combination system 110 can send a message, task, or instruction to the asset combination system 110 via the network 130 that allows for the modeling dataset 122, modeler circuit 124, data control circuit 126, and/or content control circuit 128 to be perform an update.

The data sources 170 can provide data to the asset combination system 110 and/or user device 140. In some arrangements, the data sources 170 can be structured to collect data from other devices on network 130 (e.g., user devices 140 and/or other third-party devices) and relay the collected data to the asset combination system 110 and/or user device 140. In some embodiments, the asset combination system 110 may request data associated with specific data stored in the data source (e.g., data sources 170). For example, in some arrangements, the data sources 170 can support a search or discovery engine for Internet-connected devices. The search or discovery engine may provide data from other providers that, when used to update an asset integration parameter to modify associations between assets that may be combined (e.g., asset integration parameter used by the modeler circuit 124 based on data from the modeling dataset 122), will cause an update to the associations between the assets that may be combined.

With reference again to FIG. 1, the provider system 135 is controlled by, managed by, owned by, and/or otherwise associated with a provider, such as a bank, a credit union, an appraiser, a health care institution, a governmental institution, or other institutions (e.g., credit card companies, financial institutions (FI), insurance institutions, etc.). In some embodiment, the provider system may, for example, comprise one or more servers, each with one or more processing circuits including one or more processors configured to execute instructions stored in one or more memory devices, send and receive data stored in the one or more memory devices, and perform other operations to implement the operations described herein associated with certain logic and/or processes depicted in the figures. In some instances, the provider system 135 includes and/or has various other devices communicably coupled thereto, such as, for example, desktop or laptop computers (e.g., tablet computers), smartphones, wearable devices (e.g., smartwatches), and/or other suitable devices.

The provider system 135 may also store various individual information, asset information, lifespan prediction parameters, asset integration parameters, and various other information. In some instances, the provider system 135 is configured to retrieve and transmit various customer data stored within the provider system 135 to various components within the computing environment 100 to enable the various methods, functions, and processes described herein.

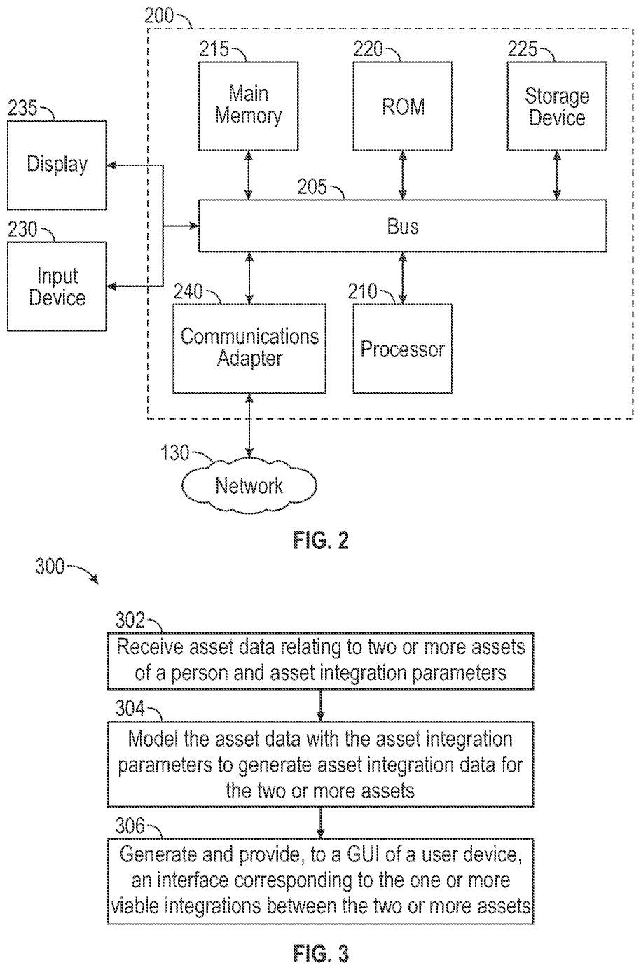

Referring now to FIG. 2, a depiction of a computing system 200 is shown. The computing system 200 can be used, for example, to implement the computing environment 100, asset combination system 110, provider systems 135, user devices 140, data sources 170, and/or various other example systems described in the present disclosure. The computing system 200 includes a bus 205 or other communication component for communicating information and a processor 210 coupled to the bus 205 for processing information. The computing system 200 also includes main memory 215, such as a random-access memory (RAM) or other dynamic storage device, coupled to the bus 205 for storing information, and instructions to be executed by the processor 210. Main memory 215 can also be used for storing position information, temporary variables, or other intermediate information during execution of instructions by the processor 210. The computing system 200 may further include a read only memory (ROM) 220 or other static storage device coupled to the bus 205 for storing static information and instructions for the processor 210. A storage device 225, such as a solid-state device, magnetic disk or optical disk, is coupled to the bus 205 for persistently storing information and instructions.

The computing system 200 may be coupled via the bus 205 to a display 235, such as a liquid crystal display, or active matrix display, for displaying information to a user. An input device 230, such as a keyboard including alphanumeric and other keys, may be coupled to the bus 205 for communicating information, and command selections to the processor 210. In some arrangements, the display 235 of the input device 230 has a touch screen. The input device 230 can include any type of biometric sensor, a cursor control, such as a mouse, a trackball, or cursor direction keys, for communicating direction information and command selections to the processor 210 and for controlling cursor movement on the display 235.

In some arrangements, the computing system 200 may include a communications adapter 240, such as a networking adapter. Communications adapter 240 may be coupled to bus 205 and may be configured to enable communications with the network 130 and/or other computing systems. In various illustrative arrangements, any type of networking configuration may be achieved using communications adapter 240, such as wired (e.g., via Ethernet), wireless (e.g., via Wi-Fi, Bluetooth), satellite (e.g., via GPS) pre-configured, ad-hoc, LAN, WAN.

According to various arrangements, the processes that effectuate illustrative arrangements that are described herein can be achieved by the computing system 200 in response to the processor 210 executing an arrangement of instructions contained in main memory 215. Such instructions can be read into main memory 215 from another computer-readable medium, such as the storage device 225. Execution of the arrangement of instructions contained in main memory 215 causes the computing system 200 to perform the illustrative processes described herein. One or more processors in a multi-processing arrangement may also be employed to execute the instructions contained in main memory 215. In alternative arrangements, hard-wired circuitry may be used in place of or in combination with software instructions to implement illustrative arrangements. Thus, arrangements are not limited to any specific combination of hardware circuitry and software.

Although an example processing system has been described in FIG. 2, arrangements of the subject matter and the functional operations described in this specification can be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to a suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the arrangements of FIG. 2 as singular, stand-alone devices, one of ordinary skill in the art will appreciate that, in some arrangements, the computing system 200 may include virtualized systems and/or system resources. For example, in some arrangements, the computing system 200 may be a virtual switch, virtual router, virtual host, or virtual server. In various arrangements, computing system 200 may share physical storage, hardware, and other resources with other virtual machines. In some arrangements, virtual resources of the network 130 (e.g., network 130 of FIG. 1) may include cloud computing resources such that a virtual resource may rely on distributed processing across more than one physical processor, distributed memory, etc.

As used herein, the term “resource” refers to a physical or virtualized (for example, in cloud computing environments) computing resource needed to execute computer-based operations. Examples of computing resources include computing equipment or device (server, router, switch, etc.), storage, memory, executable (application, service, and the like), data file or data set (whether permanently stored or cached), and/or a combination thereof (for example, a set of computer-executable instructions stored in memory and executed by a processor, computer-readable media having data stored thereon, etc.).

With an example structure of the computing environment 100 being described above, example processes performable by the computing environment 100 (or components/systems thereof) will be described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

Referring now to FIG. 3, a flowchart for a method 300 of providing indicators illustrating that two or more assets of an entity may be combined is shown, according to some embodiments. Asset combination system 110 can be configured to perform method 300. Further, any computing device described herein can be configured to perform method 300. The GUI of method 300 may be provided by and/or accessible by the user client application 154 and content control circuit 128, for example. The method 300 may be performed by the asset combination system 110 or the user device 140, described above pertaining to FIGS. 1 & 2. In some embodiments, method 300 begins in response to receiving, by a user device (e.g., user device 140) and/or through a user client application (e.g., user client application 154), data from a dataset (e.g., user device dataset 152). The data can include asset data relating to assets or user data. In some embodiments, method 300 begins when the asset combination system 110 receives data via the network 130.

The method 300 begins with the processing circuit (e.g., asset combination system 110) receiving asset data and asset integration parameters, at step 302. The asset data may relate to assets of an entity and may include names of the assets, valuations of the assets (e.g., a balance of an account, a value of an item, etc.), photographs of the assets, a type of the asset (e.g., tangible assets, intangible assets, etc.), a custodian of the assets, or other information relating to the assets. The asset integration parameters may relate to data, rules, and/or guidelines that may be used to determine the feasibility and/or favorability of combining the assets of the entity. For example, in some instances, a user may initiate an asset integration analysis through a user device (e.g., the user device 140) by uploading asset data relating to the assets and information concerning a combination of the assets. In some instances, the information concerning the combination of the assets may include all of the asset integration parameters required to perform the asset integration analysis or the modeler circuit 124 may need to receive additional asset integration parameters from a different source (e.g., the provider system 135, the data source 170, etc.). For example, a user may request that an asset integration analysis be performed through the user interface of the user device 140 and may also upload asset data relating to the assets and asset integration parameters relating to the assets to the user device 140. The asset integration parameters uploaded by the user may include all of the asset integration parameters or the modeler circuit 124 may need to receive additional asset integration parameters from a different source (e.g., the provider system 135, the data source 170, etc.).

In some instances, the processing circuit may receive liability data and asset integration parameters. The liability data may relate to liabilities of the entity and may include names of the liabilities, valuations of the liabilities, photographs of the liabilities, or other information relating to the liabilities. The liability integration parameters may relate to data, rules, and/or guidelines that may be used to determine the feasibility and/or favorability of combining the liabilities of the entity. For example, in some instances, the user may initiate a liability integration analysis through the user device by uploading liability data relating to the liabilities and information concerning a combination of the liabilities. In some instances, the information concerning the combination of the liabilities may include all of the liability integration parameters required to perform the liability integration analysis or the modeler circuit 124 may need to receive additional liability integration parameters from a different source (e.g., the provider system 135, the data source 170, etc.).

In some instances, the processing circuit may receive asset distribution parameters from two or more references where a first of the references takes precedence over a portion of a second of the references. The references may relate to the specific conditions, proportions, or methods by which different assets will be distributed to beneficiaries after the entity ceases to exist. For example, the references may include a will of the entity, a trust created by the entity to manage the assets of the entity, account specific documents, beneficiary designations, intestacy laws, or another means of controlling how different assets will be distributed after the entity ceases to exist. The asset distribution parameters may relate to the guidelines, rules, or criteria set in place by the references to govern how assets of the entity are divided and allocated among beneficiaries. In some instances, the references may conflict in regard to the distribution of the assets and one of the references may take precedence over (e.g., take priority over, overrule, etc.) another of the references. The asset distribution parameters would then rely on the one of the references that takes precedence over the other of the references. For example, a first portion of a first reference may specify that a first asset be distributed to a first beneficiary and a second portion of a second reference may specify that the first asset be distributed to a second beneficiary. If the first portion of the first reference takes precedence over the second portion of the second reference, then the asset distribution parameters will include that the first asset should be distributed to the first beneficiary.

In some instances, the processing circuit can be further configured to model the portion of the second of the references that the first of the references takes precedence over to generate suggestion data. In some instances, the suggestion data corresponds to recommendations to make one or more changes to the first of the references or the portion of the second of the references that would result in the first of the references no longer taking precedence over the portion of the second of the references. For example, the suggestion data may include recommending a change to the first of the references from specifying that a first asset be distributed to a first beneficiary to specifying that the first asset be distributed to a second beneficiary when the portion of the second of the references specifies that the first asset be distributed to the second beneficiary. As another example, the suggestion data may include recommending a change to the portion of the second references from specifying that a first asset be distributed to a second beneficiary to specifying that the first asset be distributed to a first beneficiary when the first of the references specifies that the first asset be distributed to the first beneficiary. In some instances, the suggestion data may recommend making changes to the first of the references instead of the portion of the second of the references due to the first of the references being easier to change than the portion of the second of the references, due to the first of the references being less robust (e.g., legally weaker, easier to challenge, etc.) than the portion of the second of the references, or due to another reason (e.g., a first institution that holds the first of the references is easier to work with than a second institution that holds the second of the references, changing the first of the references costs less than changing the second of the references, etc.).

In some instances, the processing circuit utilize the suggestion data to make one or more changes to the first of the references or the portion of the second of the references such that the first of the references no longer takes precedence over the portion of the second of the references. For example, the processing circuit may adjust the first of the references from specifying that a first asset be distributed to a first beneficiary to specifying that the first asset be distributed to a second beneficiary when the portion of the second of the references specifies that the first asset be distributed to the second beneficiary such that the first of the references no longer takes precedence over the portion of the second of the references.

In some instances, the processing circuit may generate one or more precedence instructions that include a process to eliminate the first of the references taking precedence over the portion of the second of the references. For example, if a will takes precedence over a portion of a title, the precedence instructions may include a process that the user would need to follow so that the will does not take precedence over the portion of the title (e.g., changing the will to match the portion of the title, changing the portion of the title to match the will, etc.).

In some instances, the processing circuit may receive individual data relating to the person and lifespan projection parameters. The individual data may refer to information relating to a person that may be used to determine characteristics about the person or predict aspects of a life of the person such as health insurance data, medical data, pharmacy data, medical event data, purchase decisions, travel information, decisions to update asset distribution parameters, age data, actuarial tables, or other information related to the life of the person. For example, individual data could include determining that the person has reduced their out of state purchases per year from 30% to 10%, which may indicate that the person may have traveled less. The lifespan projection parameters may refer to various factors that can contribute to predicting how long a person may live such as lifestyle factors, genetic factors, health assessments, or other individual data that may contribute to determining how long a person may live. For example, an increase in medical spending may indicate that a person may be in poor health, which may be related with a shorter lifespan projection.

Once the processing circuit has received the asset data and the asset integration parameters, the processing circuit is configured to model the asset data with the asset integration parameters to generate asset integration data for two or more of the assets, at step 304. The asset integration data may correspond to the two or more of the assets that can be combined based on the asset integration parameters. For example, the asset data may include a first asset and a second asset held by a person, and the asset integration parameters may include a parameter that indicates that the first asset may be combined with the second asset. The processing circuit can model the asset data with the asset integration parameters to generate asset integration data that includes a potential combination of the first asset and the second asset. As another example, a person may hold a first retirement account associated with a first employer and a second retirement account associated with a second employer. The processing circuit can model the asset data associated with the first retirement account and the second retirement account with asset integration parameters that include a type of account for the first retirement account and the second retirement account to generate asset integration data that indicates that the first retirement account may be combined with the second retirement account.

In some instances, the processing circuit may take into account penalties for combining assets when modeling the asset data with the asset integration parameters to generate the asset integration data and include the penalties in the asset integration data. For example, a 401 k account may be combined with a savings account, but there may be a tax penalty for combining the 401 k account with the savings account. The asset integration data may include these penalties.

In some instances, the process of modeling can include using techniques such as machine learning, statistical analysis, and pattern recognition to establish relationships between data and parameters and generate resulting data based on those relationships. In some embodiments, modeling can begin with the selection of an appropriate model based on the data and the parameters. It should be understood that the term modeling herein encompasses a wide range of techniques and approaches aimed at understanding relationships within data. This could include anything from statistical methods and rule-based systems to machine learning algorithms, depending on the nature of the data. Thus, modeling involves selecting techniques based on the specific characteristics of the data, ensuring that the chosen method or methods accurately captures relationships.

In some instances, the model parameters can be trained and optimized using the cleaned, classified, and linked data and parameters. This training process can include using algorithms to adjust the model parameters such that the error between the model's predictions and the actual outcomes is minimized. The modeling process can also include feature engineering, which is the process of creating new features or modifying existing ones to improve the model's power. For example, instead of modeling a first asset associated with an institution and a second asset associated with the institution to determine if the first asset may be combined with the second asset, a feature that sets that the first asset may be combined with the second asset if they are both associated with the institution might result in a more efficient model due to the fact that all of the assets associated with the same institution may be combined.

Once one or more models or techniques are trained and/or optimized, the processing circuits can use the model to generate resultant data. The resultant data could be a mathematical representation, a decision tree, a set of rules, or any other structure that captures the relationships between different data points. Moreover, the modeling process can include various safeguards to ensure privacy and security of user data (e.g., anonymizing the data).

In some embodiments, the processing circuits can use rule-based systems to model the data and the parameters. Rule-based systems can be where predefined rules are created by the processing circuits (or domain experts) to infer outcomes based on given conditions. For example, if a 401 k account cannot be combined with a savings account without incurring a tax penalty, a rule might state that a 401 k account cannot be combined with a savings account. This rule can then be applied to the process to limit the process to modeling the data with parameters related to the 401 k account.

In some instances, after the processing circuit has generated the asset integration data, the processing circuit can receive new or updated asset data and/or asset integration parameters. For example, the processing circuit may be configured to continuously monitor and receive new information (e.g., from the user device 140, from the data source 170, from the provider system 135, etc.) and determine the effect on the asset integration data. New data can affect modeling results of the processing circuit modeling the asset data with the asset integration parameters, and therefor the asset integration data. For example, a rule guiding how assets may be combined could be updated (e.g., change to a law regarding a combination of tax benefit accounts, etc.) after the processing circuit has already modeled the asset data with the asset integration parameters. A source (e.g., user device 140, data source 170, or provider system 135) may then send an update of the rule guiding asset integration to the processing circuit. Because updates to the asset integration parameter can be a significant factor affecting the asset integration data, processing circuit could model the updated asset integration parameters with the asset data to generate updated asset integration data. In some embodiments, the processing circuit may notify the user of the updated asset integration data (e.g., through the user device 140, through a notification of a change to the asset integration data, etc.). As another example, the asset data may be updated after a first asset and a second asset have been combined to form a third asset. The processing circuit may then model the updated asset data with the asset integration parameters to generate updated asset integration data. The updated asset integration data may then correspond to the third asset and a fourth asset that may be combined based on the asset integration parameters if there is a fourth asset that may be combined with the third asset based on the asset integration parameters.

In some instances, the processing circuit may integrate the two or more of the assets based on the asset integration data such that the two or more of the assets are combined into a single asset. For example, the asset integration data may indicate that a first asset and a second asset may be combined. The processing circuit may then combine the first asset with the second asset to form a third asset, such that a total number of assets is reduced. For example, the asset integration data may relate to a savings account and a home savings account that may be combined. The processing circuit may then roll the home savings account into the savings accounts to reduce the total number of assets. In some embodiments, the processing circuit may integrate the two or more of the assets after receiving an input from a user device. For example, the asset distribution data may indicate that a first account and a second account may be combined and then after receiving a selection of an actionable activity from a user device, the processing circuit may combine the first account and the second account. In some embodiments, the processing circuit may automatically integrate the two or more of the assets after generating the asset integration data.

In some instances, the processing circuit may model the asset integration data to generate one or more integration instructions that include a process to combine the two or more of the assets. For example, the asset integration data corresponds to a first account and a second account that may be combined. The processing circuit may then model the combination of the first account and the second account to determine a process that the user would need to follow to combine the first account and the second account. For example, the asset integration data may correspond to a first retirement account that may be combined with a second retirement account. The processing circuit may then model combining the first retirement account and the second retirement account to determine the process to combine the first retirement account and the second retirement account, such as submitting a request to a holder of the second retirement account to roll the account into the first retirement account. In some embodiments, the processing circuit may model the asset integration data to generate the integration instructions after receiving an input from a user device. In some embodiments, the processing circuit may automatically model the asset integration data to generate the integration instructions after generating the asset integration data.

In some instances, the processing circuit may model the asset data with the asset distribution parameters to generate distribution data for the assets. The distribution data may correspond to one or more association between the asset and the beneficiaries of the entity, where the associations indicate the beneficiary that each of the assets will be distributed to after the entity ceases to exist. For example, the asset distribution parameters may include that a first asset should be passed on to a first beneficiary after the entity ceases to exist. The modeler circuit 124 can model the asset data, including data related to the first asset, with the asset distribution parameters to generate distribution data that includes an association between the first asset and the first beneficiary.

In some instances, the processing circuit may identify a variation between the asset distribution data and the second of the references. The variation may be related to the portion of the second of the references that the first of the references took priority over. For example, the variation could be that a will specifies that a property should be distributed to a spouse, but the asset distribution data associates the property with a sibling due to a deed for the property specifying that the property should be distributed to the sibling and the deed taking precedence over the will in regards to the property.

In some instances, the processing circuit may resolve the variation between the asset distribution data and the second of the references such that the variation is eliminated. For example, the processing circuit may adjust the second of the references, such that there are no variations between the asset distribution data and the second of the references. For example, a will included in the asset distribution data could specify that an account should be distributed to a child, but an account specific document that takes precedent over the will specifies that the account should be distributed to an ex-spouse. The processing circuit may adjust the account specific document to specify that the account should be distributed to the child in order to eliminate the variation between the will and the account specific document. In some embodiments, the processing circuit may resolve the variation between the asset distribution data and the second of the references after identifying the variation between the asset distribution data and the second of the references.

In some instances, the processing circuit may generate one or more resolution instructions that include a process to eliminate the variation between the asset distribution data and the second of the references. For example, the processing circuit may model the variation between the asset distribution data and the second of the references to determine a process that the user would need to follow to eliminate that variation between the asset distribution data and the second of the references. For example, a will included in the asset distribution data could specify that a vehicle should be distributed to a sibling, but a title could specify that the vehicle should be distributed to a parent. The processing circuit may then model the variation between the will and the title that the user would need to follow to modify the tittle to specify that the vehicle should be distributed to the sibling to eliminate the variation between the will and the title, such as booking an appointment with the department of motor vehicles and updating the title. In some embodiments, the processing circuit may model the variation between the asset distribution data and the second of the references to determine the process to eliminate the variation between the asset distribution data and the second of the references after receiving an input from a user device. In some embodiments, the processing circuit may model the variation between the asset distribution data and the second of the references to determine the process to eliminate the variation between the asset distribution data and the second of the references after identifying the variation between the asset distribution data and the second of the references.

In some instances, the processing circuit may model the liability data with the liability integration parameters to generate liability integration data for the two or more liabilities. The liability integration data may correspond to the two or more of the liabilities that may be combined based on the liability integration parameters. For example, the liability data may include a first liability and a second liability held by a person, and the liability integration parameters may include a parameter that indicates that the first liability may be combined with the second liability. The modeler circuit 124 can model the liability data with the liability integration parameters to generate liability integration data that includes a potential combination of the first liability and the second liability. In addition to modeling the liability data with the liability integration parameters, the processing circuit may perform similar operations on the liability data as performed on the asset data described above.

In some instances, the processing circuit may model the individual data with the lifespan projection parameters to generate a projected passing date for a person associated with the entity. The projected passing date may represent an estimated date that the person may pass away. For example, the individual data may include a medicine that the person has been prescribed and the lifespan projection parameters may include an association between the medicine and a projected lifespan of 3 more years. The projected passing date of the person may then be 3 years in the future.

Once the processing circuit has generated the asset integration data for the two or more of the assets, the processing circuit may then generate and provide an interface corresponding to the asset integration data, at step 306. The processing circuit may provide the interface to a graphical user interface (GUI) of a user device (e.g., the user client application 154 of the user device 140). The interface may include elements (e.g., text, videos, images, buttons, etc.) indicating the two or more of the assets that may be combined. For example, the elements may be arrows pointing between the two or more of the assets that may be combined. In some instances, the elements of the interface may include a recommendation for the user to integrate the two or more of the assets that may be combined.

In some instances, the processing circuit may update the interface to additionally correspond to the liability integration data. Updating to the interface may include updating the elements such the elements also indicate the two or more of the liabilities that may be combined. In some instances, the elements of the interface may include a recommendation for the user to integrate the two or more of the liabilities that may be combined.

In some instances, as described below, the processing circuit is configured to determine a recommended transaction, such as a combination of a first asset and a second asset for the user, using one or more machine learning models. Accordingly, in some instances, the interface may be arranged such that one of the elements indicating that the first asset and the second asset may be combined is displayed more prominently than the other of the elements indicating that other of the assets may be combined. For example, in some instances, the one of the elements indicating that the first asset and the second asset may be combined may be bolded, underlined, enlarged, or moved to an uppermost location of the interface (i.e., the first choice). In some instances, upon the one or more machine learning models determining that the recommended combination for the user has changed, the processing circuit is configured to modify or update the interface provided to the GUI to rearrange or redesign the elements indicating the assets that may be combined such that the new recommended combination is prominently displayed instead of the previous recommended combination.

Furthermore, in some instances, the elements indicating the assets that may be combined shown within the interface provided to the GUI may be arranged within the interface based on their estimated relevance to the user. For example, in some instances, the processing circuit is configured to estimate the most relevant and/or useful combinations of the assets for inclusion within the interface using one or more machine learning models of the processing circuit. In some instances, the processing circuit may train the one or more machine learning models to identify the most relevant and/or useful combinations of the assets for inclusion using various training data. The training data may include historical combinations of similar assets by users, and corresponding user information (e.g., income level, number of dependents, geographical location) associated with those users. In some instances, the training data may be data compiled over time from a variety of users associated with the provider and stored within a database associated with the provider system 135.

Accordingly, once the one or more machine learning models have been trained, the processing circuit may apply the historical combinations of similar assets by users and various user information pertaining to the user to the one or more machine learning models to identify the most relevant and/or useful combinations of the assets for inclusion on the interface provided to the GUI. The processing circuit may further arrange the elements indicating the assets that may be combined specifically according to their estimated relevance. For example, in some instances, the most relevant elements may be arranged in a top left corner of the interface. The elements may then be arranged in descending order of relevance from left to right and top to bottom within the interface. In some instances, the processing circuit is configured to utilize various feedback information (e.g., assets actually combined by the user) received from the user (e.g., via the user device 140) to retrain or otherwise update the one or more machine learning models. Accordingly, in some instances, the processing circuit may rearrange the elements on the interface based on the updated machine learning models and their associated outputs.

In some instances, the processing circuit may generate and provide an instruction interface corresponding to the integration instructions. The processing circuit may provide the instruction interface to the GUI of the user device and the instruction interface may include steps in the process to combine the two or more of the assets. For example, the integration instructions may include that the user needs to fill out a form and deliver the form to a bank to roll a first bank account into a second bank account.

In some instances, the processing circuit may generate and provide a variation interface corresponding to the variation between the asset distribution data and one of the references. The processing circuit may provide the variation interface to the GUI of the user device and the variation interface may include a reference to the variation between the asset distribution data and the one of the references. In some instances, the variation interface may also include instructions for a process that the user would need to take to eliminate the variation between the asset distribution data and the one of the references.

In some instances, the processing circuit may generate and provide a projected passing report to a recipient. The processing circuit may provide the projected passing report to the GUI of the user device and the projected passing report may include the projected passing date of the person associated with the entity and the asset data of the assets of the entity. In some instances, the recipient of the projected passing report may be the person, a representative responsible for managing the assets and/or liabilities held by the entity after the person is deceased, or a beneficiary of at least one of the assets of the entity. In some instances, the projected passing report may display different amounts on information based on the recipient intended for the projected passing report. For example, the representative of the entity may receive a complete version of the projected passing report with all of the assets of the entity included while one of the beneficiaries may receive a reduced version of the projected passing report with only the assets associated with the one of the beneficiaries included. In some instances, the projected passing report may include the asset integration data, the liability integration data, or any other information described above. In some instances, the processing circuit may provide the projected passing report to the recipient at a predetermined time before the projected passing date (e.g., three years before the projected passing date, six months before the projected passing date, etc.). In some instances, the processing circuit may generate and provide the projected passing report to the recipient upon determining that the person associated with the entity has passed away. The processing circuit may determine that the person has passed away from information available from the user device 140, provider systems 135 (e.g., a coroner's report from a hospital), or from the data sources 170 (e.g., an obituary in a newspaper).

In some instances, the processing circuit may generate and provide an event report to the recipient. The processing circuit may provide the event report to the GUI of the user device and the event report may include a projected event date of the person associated with the entity (e.g., a projected graduation date, a projected childbirth date, a projected retirement date, etc.) and the asset data of the assets of the entity. In some instances, the event report may include the asset integration data, the liability integration data, or any other information described above.

Referring now to FIG. 4A, an illustration of a configuration of a user interface 400 on the user device 140 is shown. The user interface 400 may be presented within the user client application 154. In some embodiments, the user interface 400 is generated and provided by the content control circuit 128 and transmitted to the user device 140 to be displayed to a user.

As illustrated, the user interface 400 includes a plurality of asset indicators 402, a plurality of integration indicators 404, and a recommendation indicator 406. The asset indicators 402 displays content related to the assets to the user such that the user may identify each of the assets. The content related to the assets may include descriptions of the assets, photographs of the assets, videos of the assets, or other elements that may relate to the assets.

The integration indicators 404 are an indication between at least two of the asset indicators 402 that indicates that the assets corresponding to the at least two of the asset indicators 402 may be combined based on the asset integration data generated at step 304, discussed above. As illustrated, the integration indicators 404 can be both a text prompt (e.g., “Integration Viable”) and an arrow between the assets indicating that the assets may be combined. In some instances, the integration indicator 404 may include a variety of other text-based, color-based, or symbol-based indicators indicative that the assets may be combined. For example, the integration indicator 404 may include one or more of a color-coded indicator (e.g., a red indicator that the assets may not be combined, a yellow indicator indicates that the assets may be combined with a penalty, and a green indicator indicates that the assets may be combined), a predetermined shape-based symbol (e.g., a plus sign between the asset indicators 402 to indicate that the assets may be combined, a minus sign between the asset indicators 402 to indicate that the assets may not be combined) or any other suitable type of integration indicators 404.

In some instances, the recommendation indicator 406 includes a recommendation for a user to integrate the two or more assets that were determined to be able to be combined at step 304, discussed above. For example, in some instances, the recommendation indicator 406 includes recommending that the user combine a first asset and a second asset (e.g., “Recommendation: Integrate Asset #3 and Asset #4”), that the user does not combine a first asset and a second asset, that the user combine a first liability and a second liability, and that the user combine more than two of the assets. In some other instances, the recommendation indicator includes additional or alternative recommendations, as desired for a given application.

Referring now to FIG. 4B, an illustration of a configuration of the user interface 400 on the user device 140 is shown. As illustrated, the user interface 400 includes the asset indicators 402, the integration indicators 404, the recommendation indicator 406, and an actionable item 408. The actionable item 408 may be associated with the two or more of the assets that were determined to be able to be combined at step 304, discussed above. In some instances, the customer may select to perform the recommendation included in the recommendation indicator 406 by selecting the actionable item 408. For example, in some instances, the actionable item 408 may allow for the processing circuit to integrate the two or more assets that were determined to be able to be combined, to model the asset integration data to generate one or more integration instructions, to link the user to a different application related to making adjustments to at least one of the two or more of the assets, or take other actions based on the recommendation included in the recommendation indicator 406.

Referring now to FIG. 4C, an illustration of a configuration of the user interface 400 on the user device 140 is shown. As illustrated, the user interface includes the asset indicators 402, the integration indicators 404, and a plurality of liability indicators 410. The liability indicators 410 displays content related to the assets to the user such that the user may identify each of the assets. The content related to the assets may include descriptions of the assets, photographs of the assets, videos of the assets, or other elements that may relate to the assets. As illustrated, the integration indicators 404 may additionally be an indication between at least two of the liability indicators 410 that indicates that the liabilities corresponding to the at least two of the liability indicators 410 may be combined based on the liability integration data generated at step 304, discussed above.

Referring now to FIG. 4D, an illustration of a configuration of the user interface 400 on the user device 140 is shown. As illustrated, the user interface 400 includes a first reference indicator 420, the asset indicators 402, a plurality of beneficiary indicators 424, a first association indicator 426, a second reference indicator 430, and a second association indicator 432. The first reference indicator 420 displays content related to the first reference of the entity that contributes to the asset distribution parameters of the assets of the entity. The second reference indicator 430 displays content related to the second reference of the entity that contributes to the asset distribution parameters of the assets of the entity. The first reference indicator 420 and the second reference indicator 430 may include descriptions of the references, photographs of the references, videos of the references, or other elements that may relate to the references. In some instances, the user interface 400 may include additional reference indicators (e.g., a third reference indicator, a fourth reference indicator, etc.). The beneficiary indicators 424 display content related to the beneficiaries of the assets of the entity. The beneficiary indicators 424 may include descriptions of the beneficiaries, photographs of the beneficiaries, videos of the beneficiaries, or other elements that may relate to the beneficiaries.

As illustrated, the first association indicator 426 is an arrow between the asset indicators 402 and the beneficiary indicators 424 that indicates that the first reference specifies that the asset represented by the asset indicator 402 will be inherited by the beneficiary represented by the beneficiary indicator 424 after the entity ceases to exist. In other instances, the first association indicator 426 may include a variety of text-based, color-based, or symbol-based indicators indicative that the first reference specifies that the asset will be inherited by the beneficiary.

As illustrated, the second association indicator 432 is an arrow between the asset indicators 402 and the beneficiary indicators 424 that indicates that the second reference specifies that the asset represented by the asset indicator 402 will be inherited by the beneficiary represented by the beneficiary indicator 424 after the entity ceases to exist. In other instances, the second association indicator 432 may include a variety of text-based, color-based, or symbol-based indicators indicative that the second reference specifies that the asset will be inherited by the beneficiary.

In some instances, the first association indicator 426 and the second association indicator 432 may include a variety of text-based, color-based, or symbol-based indicator indicative if the first reference takes precedence over the second of the references with regards to the asset represented by the asset indicator 402 or vice versa. For example, the first association indicator 426 and the second association indicator 432 may include one or more of a color-coded indicator (e.g., a green indicator that the reference takes precedence, a yellow indicator that the references are equal, a red indicator that the reference does not take precedence, a predetermined shape-based symbol (e.g., a plus sign that the reference takes precedence, an equal sign that the references are equal, a minus sign that the reference does not take precedence), or any other suitable type of the first association indicator 426 and the second association indicator 432.

Referring now to FIG. 4E, an illustration of a configuration of the user interface 400 on the user device 140 is shown. As illustrated, the user interface includes a report 440, a date element 442, and the asset indicators 402. The report 440 displays content related to the person associated with the entity. The content related to the person may include descriptions of the person, photographs of the person, videos of the person, or other elements that may relate to the person. In some instances, the report 440 may include educational videos or other educational material related to the process of passing assets from an owner to a beneficiary. The educational videos or other educational material may be selected as being relevant to the assets held by the entity or a situation of the person associated with the entity. For example, if the assets of the entity include a trust, the educational videos or other educational material may relate to trusts.

In some instances, the report 440 is a projected passing report of the person associated with the entity and includes content related to the death of the person. The content related to the death of the person may include a text prompt (e.g., “Projected Passing Report”), funeral details, gravestone details, information regarding the assets of the entity, obituary details, and other information that may be related to the death of the person. In other instances, the report 440 may be related to a different life event of the person (e.g., a retirement report, a childbirth report, etc.). As illustrated, the report 440 may include the asset indicators 402 associated with assets of the entity. In some instances, the report 440 may also include beneficiary indicators associated with the asset indicators 402. The association of the beneficiary indicators with the asset indicators 402 may be pulled from the asset distribution data, may be manually set by the person, or may be determined through an alternate means (e.g., a combination of pulling from the asset distribution data and being manually set by the person, etc.).

The date element 442 displays content related to a date relevant to the person. In some instances, the date element 442 is a projected passing date of the person. The date element 442 may include a text prompt (e.g., “Projected Passing Date:” followed by a date”, a calendar depicting the projected passing date, or other information that may be related to the projected passing date. In other instances, the date element 442 may be related to the different life events of the person discussed with regards to the report 440.

It should be understood that no claim element herein is to be construed under the provisions of 35 U.S.C. § 112(f) unless the element is expressly recited using the phrase “means for.”

As used herein, the term “circuitry” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory).

Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud-based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

Example systems and devices in various embodiments might include a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the smart table system may be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. A system comprising:
a processing circuit comprising memory and one or more processors, the processing circuit configured to:
receive asset data relating to assets of an entity and asset integration parameters;
model the asset data with the asset integration parameters to generate asset integration data for the assets, wherein the asset integration data corresponds to two or more of the assets that may be combined based on the asset integration parameters; and
generate and provide, to a graphical user interface (GUI) of a user device, an interface corresponding to the asset integration data, wherein the interface comprises a plurality of elements illustrating the two or more of the assets that may be combined.

2. The system of claim 1, wherein the plurality of elements comprise a recommendation to integrate the two or more of the assets that may be combined.

3. The system of claim 2, wherein the interface further comprises an actionable item associated with the asset integration data; and
wherein in response to receiving a selection of the actionable item from the user device, the processing circuit is further configured to:
integrate the two or more of the assets based on the asset integration data, wherein integrating the two or more of the assets results in the two or more of the assets being combined into a single asset.

4. The system of claim 2, wherein the interface further comprises an actionable item associated with the asset integration data; and
wherein in response to receiving a selection of the actionable item from the user device, the processing circuit is further configured to:
model the asset integration data to generate one or more integration instructions, wherein the one or more integration instructions comprise a process to combine the two or more of the assets; and
generate and provide, to the GUI of the user device, an instruction interface corresponding to the one or more integration instructions, wherein the instruction interface comprises a plurality of steps in the process to combine the two or more of the assets.

5. The system of claim 1, wherein the processing circuit is further configured to:
receive liability data relating to liabilities of the entity and liability integration parameters;
model the liability data with the liability integration parameters to generate liability integration data for two or more of the liabilities, wherein the liability integration data corresponds to the two or more of the liabilities that may be combined based on the liability integration parameters; and
update the interface corresponding to the asset integration data to additionally correspond to the liability integration data, wherein the interface further comprises the plurality of elements illustrating the two or more of the liabilities that may be combined.

6. The system of claim 5, wherein the plurality of elements comprise a recommendation to integrate at least one of the two or more of the assets that may be combined or the two or more of the liabilities that may be combined.

7. The system of claim 1, wherein the processing circuit is further configured to:
receive asset distribution parameters from two or more references, wherein a first of the references takes precedence over a second of the references;
model the asset data with the asset distribution parameters to generate asset distribution data for the assets, wherein the asset distribution data corresponds to one or more associations between one or more beneficiaries and the assets based on the asset distribution parameters;
identify a variation between the asset distribution data and the second of the references; and
generate and provide, to the GUI of the user device, a variation interface corresponding to the variation.

8. The system of claim 1, wherein the processing circuit is further configured to:
receive individual data relating to a person associated with the entity and lifespan projection parameters;
model the individual data with the lifespan projection parameters to generate a projected passing date for the person; and
generate and provide a projected passing report to a recipient, wherein the projected passing report comprises the projected passing date and the asset data.

9. The system of claim 8, wherein the individual data relating to the person comprises at least one of health insurance data, pharmacy data, or medical event data; and
wherein the recipient of the projected passing report comprises at least one of the person associated with the entity, a representative of the entity, or a beneficiary of at least one of the assets of the entity.

10. A method comprising:
receiving, by a processing circuit, asset data relating to assets of an entity and asset integration parameters;
modeling the asset data with the asset integration parameters to generate asset integration data for the assets, wherein the asset integration data corresponds to two or more of the assets that may be combined based on the asset integration parameters; and
generating and providing, to a graphical user interface (GUI) of a user device, an interface corresponding to the asset integration data, wherein the interface comprises a plurality of elements illustrating the two or more of the assets that may be combined.

11. The method of claim 10, wherein the plurality of elements comprise a recommendation to integrate the two or more of the assets that may be combined.

12. The method of claim 11, wherein the interface further comprises an actionable item associated with the asset integration data, and the method further comprises:
receiving a selection of the actionable item from the user device; and
integrating the two or more of the assets based on the asset integration data, wherein integrating the two or more of the assets results in the two or more of the assets being combined into a single asset.

13. The method of claim 11, wherein the interface further comprises an actionable item associated with the asset integration data, and the method further comprises:
receiving a selection of the actionable item from the user device;
modeling the asset integration data to generate one or more integration instructions, wherein the one or more integration instructions comprise a process to combine the two or more of the assets; and
generating and providing, to the GUI of the user device, an instruction interface corresponding to the one or more integration instructions, wherein the instruction interface comprises a plurality of steps in the process to combine the two or more of the assets.

14. The method of claim 10, further comprising:
receiving liability data relating to liabilities of the entity and liability integration parameters;
modeling the liability data with the liability integration parameters to generate liability integration data for the two or more of the liabilities, wherein the liability integration data corresponds to two or more of the liabilities that may be combined based on the liability integration parameters; and
updating the interface corresponding to the asset integration data to additionally correspond to the liability integration data, wherein the interface further comprises the plurality of elements illustrating the two or more of the liabilities that may be combined.

15. The method of claim 14, wherein the plurality of elements comprise a recommendation to integrate at least one of the two or more of the assets that may be combined or the two or more of the liabilities that may be combined.

16. The method of claim 10, further comprising:
receiving asset distribution parameters from two or more references, wherein a first of the references takes precedence over a second of the references;
modeling the asset data with the asset distribution parameters to generate asset distribution data for the assets, wherein the asset distribution data corresponds to one or more associations between one or more beneficiaries and the assets based on the asset distribution parameters;
identifying a variation between the asset distribution data and the second of the references; and
generating and providing, to the GUI of the user device, a variation interface corresponding to the variation.

17. The method of claim 10, further comprising:
receiving individual data relating to a person associated with the entity and lifespan projection parameters;
modeling the individual data with the lifespan projection parameters to generate a projected passing date for the person; and
generating and providing a projected passing report to a recipient, wherein the projected passing report comprises the projected passing date and the asset data.

18. The method of claim 17, wherein the individual data relating to the person comprises at least one of health insurance data, pharmacy data, or medical event data; and
wherein the recipient of the projected passing report comprises at least one of the person associated with the entity, a representative of the entity, or a beneficiary of at least one of the assets of the entity.

19. A non-transitory computer-readable storage medium having instructions stored thereon that, when executed by at least one processing circuit, cause the processing circuit to perform operations comprising:
receiving, by the processing circuit, asset data relating to assets of an entity and asset integration parameters;
modeling the asset data with the asset integration parameters to generate asset integration data for the assets, wherein the asset integration data corresponds to two or more of the assets that may be combined based on the asset integration parameters; and
generating and providing, to a graphical user interface (GUI) of a user device, an interface corresponding to the asset integration data, wherein the interface comprises a plurality of elements illustrating the two or more of the assets that may be combined;
wherein the plurality of elements comprise a recommendation to integrate the two or more of the assets that may be combined.

20. The non-transitory computer-readable storage medium of claim 19, wherein the operations further comprise:
receiving liability data relating to liabilities of the entity and liability integration parameters;
modeling the liability data with the liability integration parameters to generate liability integration data for the two or more of the liabilities, wherein the liability integration data corresponds to two or more of the liabilities that may be combined based on the liability integration parameters; and
updating the interface corresponding to the asset integration data to additionally correspond to the liability integration data, wherein the interface further comprises the plurality of elements illustrating the two or more of the liabilities that may be combined;
wherein the plurality of elements further comprise a recommendation to integrate the two or more of the liabilities that may be combined.
